(19) United States
(12) Patent Application Publication
(10) Pub. No.: US 2010/0259573 A1
(43) Pub. Date: Oct. 14, 2010

(54) METHOD OF CONTROLLING MARKING ON CONTINUOUS WEB PRINT MEDIA

(75) Inventors: R. Enrique Viturro, Rochester, NY (US); Paul J. McConville, Webster, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/422,366

(22) Filed: Apr. 13, 2009

(51) Int. Cl. B41J 29/38

(52) U.S. Cl. 347/9

(57) ABSTRACT

The present disclosure describes a system and method for controlling the post-marking heaters and ink spreading nip rollers employed for spreading the ink dots on the media web to provide the desired image quality. The technique employs a sensor for sensing single pixel linewidth and showthru sensor to sense showthru of the ink. The sensor outputs are combined with the temperature and pressure values of the ink spreading nips to provide an error signal to a PID controller for controlling the nip pressure and heater temperature.

### BACKGROUND

The present disclosure relates to solid ink jet marking of dots on continuous web print media from a digital image. In the aforesaid process, it is necessary to provide accurate control of spreading of the dots on the image page in order to obtain good print quality by masking eventual missing jets and improving the robustness of the image. The process includes solid ink jet marking units and heaters for heating the ink of the marked image prior to entry into spreading nip rollers for providing the desired spreading of the ink dots to give a quality image, particularly where the image is marked with multiple colorant inks. Heretofore, problems have been encountered in maintaining the quality of the image on the marked side of the web media and in controlling the showthru properties of the ink where the web is to be also marked on opposite sides thereof with desired images. It has been found difficult to control the effect of the heaters and nip pressure in the process to provide the desired quality of the marked images on the web; and, thus it has been desired to provide an improved way or means of controlling these functions for quality printing.

### BRIEF DESCRIPTION

The present disclosure describes a system and method for controlling a dot spreading subsystem employed for spreading ink dots on the media web to provide desired image quality. The subsystem consists of post-marking heaters and ink spreading nip rollers, and uses optical array sensors for sensing single pixel linewidth and show thru of ink dots in the media, and an optical array sensor, dubbed image-on-web array (IOWA) sensor, for sensing images in the process and cross-process direction. The sensor outputs are integrated with the temperature and pressure readings of the ink spreading nips to provide an error signal to a PID controller for controlling the nip pressure and temperature and the heater temperature.

### BRIEF DESCRIPTION OF THE DRAWINGS

FIG. 1 is a pictorial of the system architecture employed in the present disclosure;

FIG. 2 is an enlarged view of a portion of FIG. 1 illustrating the spreading subsystem;

FIG. 3 is a graphical presentation of pixel linewidth as a function of the spreader subsystem set points;

FIG. 4 is a control diagram of the operation of the control of the spreader subsystem; and

FIG. 5 is a block flow diagram of the control arrangement for the image sensors, spreader and heaters of the present disclosure.

### DETAILED DESCRIPTION

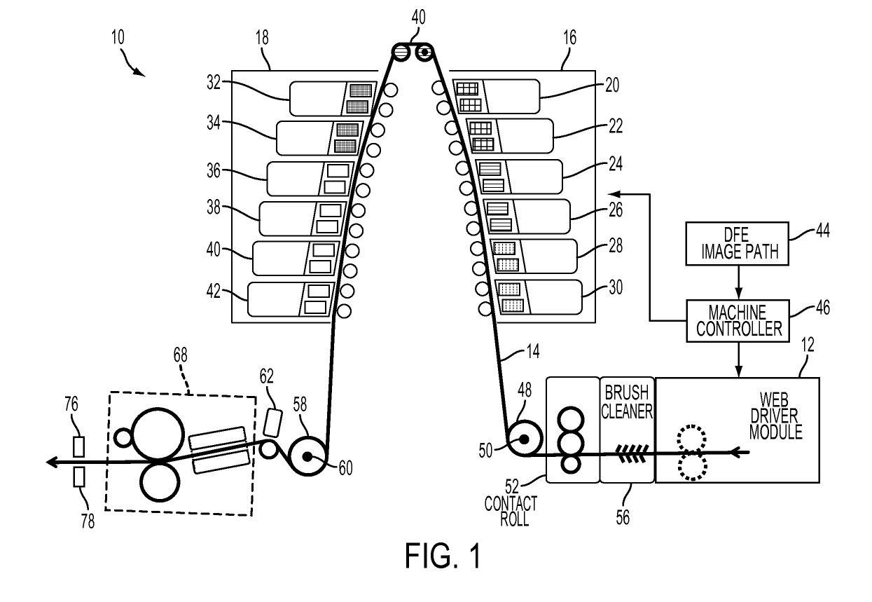

Referring to FIG. 1, a schematic diagram of the multi-colorant printing system architecture is shown wherein the system indicated generally at 10 includes a web module 12 to which the continuous media web 14 passes for marking. The module 12 includes the control and motor drives for movement and tension control of the web. For example, a load cell 40 and encoders 50 and 60 are used for sensing tension and speed in the web, respectively. The printing system 10 includes two print modules 18 and 20, furnished with print units each having several printheads to enable wide image printing. In this embodiment of the disclosure, the print units are indicated by reference numerals 20, 22, 24, 26, 28, 30, 32, 34, 38, 40, and 42 for enabling different configurations of printing, including monochrome, CMYK, and hexachrome ink printing.

A machine controller 46 shown in FIG. 1 receives video data from the digital front end 44 and is in operational control of the web driver module, feeding media, adjusting web velocity and tension, of the printing modules and spreading subsystem, and any other subsystem required for enabling printing.

The system 10 of FIG. 1 includes a web cleaning brush 36, contact nip rollers 38 and a load cell 40 for providing a signal to aid in tension control and a pre-heater roll 48 with encoder indicated generally at 50. The preheat roll is a web driving roll that also controls the temperature of the media entering the printing zone. Media temperature usually ranges between 25 C and 75 C, depending on the media properties. In the printing zone ink dots are jetted from the print heads at temperatures ranging between 110 C and 140 C, depending on the ink properties, and deposited on the media. After exiting the printing zone the ink image on media enters a leveler roll 58 whose function is to equate the ink-media by cooling. In another embodiment the leveler function is not required, as the ink-media enters directly into the spreading subsystem.

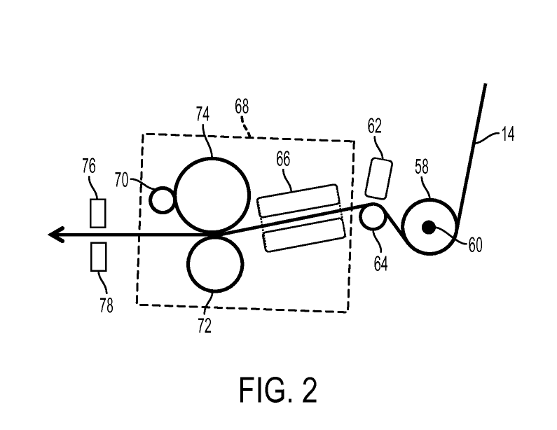

Referring to FIGS. 1 and 2, the web 14 is shown entering an image sensor system which includes a sensor for sensing the image on the web 62 and a backer roll 64, denoted by the reference characters IOWA in the drawings, and which is disposed downstream of the leveler 58 in the process direction for sensing the presence and correctness of the image marked on the web 14. The marked image on the web then enter the spreader module 68, first passing through a heater array indicated generally at 66 to adjust the ink-media temperature. The spreader module 68 includes a spreader drum 74, a pressure roll 72 and an oiler module 70, for spreading the ink drops on the web to achieve the desired image quality. In another embodiment either leveler 58 and or heater 66 are not employed, and the web 14 passes directly from the print zone 18 to the spreading rolls.

A linewidth sensor 76 and a showthru sensor 78 are provided adjacent opposite sides of the web downstream of the spreader module 68 in the process direction. The linewidth sensor senses the width of a single pixel line; and, the showthru sensor detects the ink bleed through the media to the opposite side.

The IOWA sensor is disposed upstream of the heater 66 and is operative to detect the width of a pixel line prior to entry into the spreader module. Thus, by comparison of the linewidth measurements in sensor 66 and sensor 76, the change in linewidth due to the effects of the operations in the spreader module 68 can be measured; and, from that relationship appropriate control algorithms may be applied for control of temperature and pressure applied to the web 14.

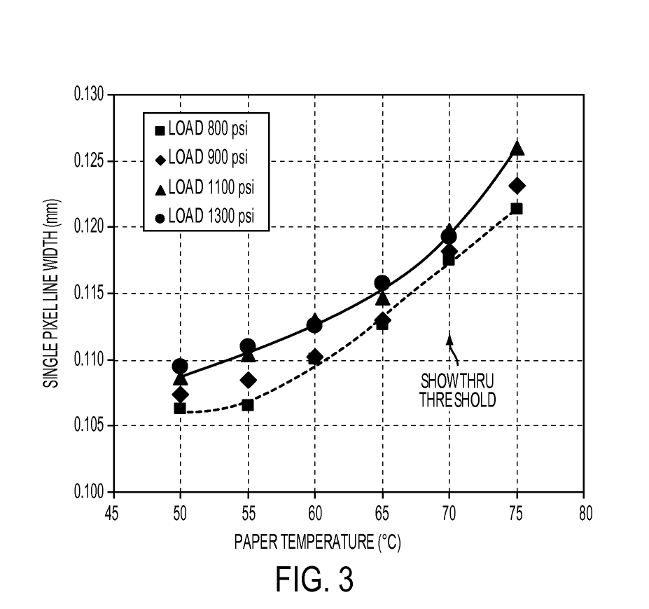

FIG. 3 illustrates the functional dependence of single pixel linewidth in microns as a function of the paper temperature in degrees centigrade and spreader roll pressure in psi. The paper stock weight used in these measurements was 75 gsm. FIG. 3 shows the functional dependence of temperature and pressure on line width for this particular ink. It also indicates the values of these parameters where the show-thru threshold is reached. Beyond these values, duplex print image quality degrades to unacceptable values. FIG. 3 provides the necessary information to construct the transfer function (such as a Jacobean transform) between the control parameters and the line width output, and to thereby construct a PID controller.

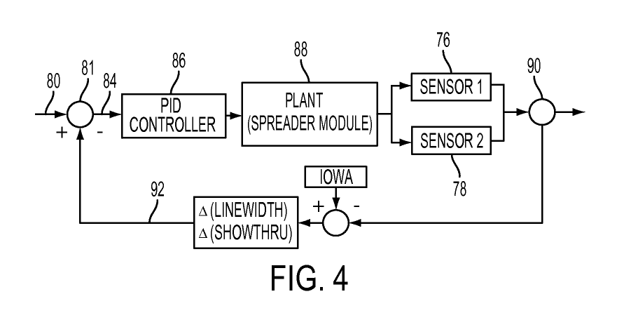

Referring to FIG. 4, a generic PID controller for the spreader module 68 is shown diagrammatically wherein the control reference signal on line 80 is summed at input junction 81 with an error feed-back signal along line 92 to output summing junction 84. The error signal from line 92 and the reference input signal 80 are applied along 84 to a proportional-integral-derivative controller 86 which outputs to the actuators at plant 88, for nip pressure and temperature. The linewidth sensor 76 and the showthru sensor 78 measure the control target on the web at the output of the block 88 and provide an integrated signal to the IOWA summing junction for computing the error and thus close the loop.

In the present practice, it has been found satisfactory to utilize a full width optical array sensor for the linewidth sensor 76 and showthru sensor 78 with a cross process resolution of 600 spots per inch or 42.3 micrometers. The IOWA sensor 62 in the present practice has a 600 spots per inch resolution. Then, after combining with appropriate signal processing techniques and statistical sampling, the sensing system provides linewidth measurements with a resolution of less than 3 micrometers (3σ). The full width array capability of this embodiment allows the determination of inboard/outboard non-uniformities of the output of the spreader module whereupon the correction includes inboard/outboard differential actuation.

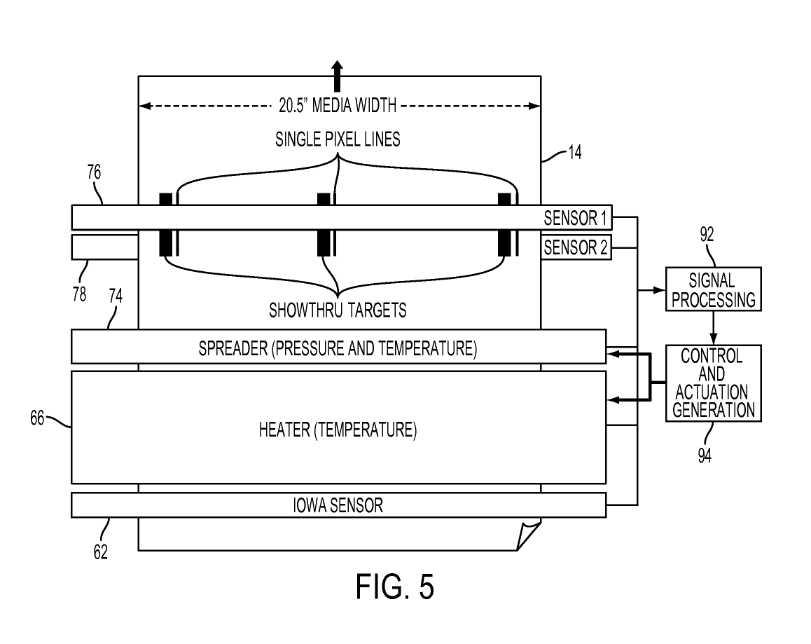

Referring to FIG. 5, a block diagram of the control arrangement for the spreader module and sensors is shown in which the sensors 76, 78 have their output signals processed in a signal processing step 92 and the signals proceed to step 94 wherein control and actuator signals are generated and the outputs provided to the spreader 74 and the heater 66. The sensors 76, 78, spreader 74 and heater 66 are shown as disposed in a full width disposition in the cross-process direction with respect to the movement of the web as shown by the black arrow in FIG. 5. In another embodiment, standard linear optical array sensors of reduced sensing width, e.g., approximately 0.5 inches long, can be used for the linewidth 76 and showthru 78 sensors, or alternatively, to also address inboard/outboard nonuniformities, a multiplicity of them positioned across the web width can be used.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of controlling ink jet marking dots on continuous web print media comprising:
(a) sensing the cross process width of a single pixel line subsequent to marking;
(b) disposing a spreader and controlling the spread of the marked dots on the web media;
(c) disposing one of a pixel linewidth sensor and a showthru sensor adjacent the web downstream of the spreader in the process direction; and,
(d) controlling the spreading of the dots in response to an output from the one of a linewidth and showthru sensor.

2. The method defined in claim 1, wherein the step of disposing one of a showthru sensor and linewidth sensor includes disposing a full width array in the cross process direction.

3. The method defined in claim 1, wherein the step of controlling includes disposing a controller and operatively connecting the controller to receive output signals from the one of the showthru and linewidth sensor.

4. The method defined in claim 1, wherein the step of disposing one of a pixel linewidth sensor and showthru sensor includes disposing a sensor with a cross process resolution of about 42 micrometers (μm).

5. The method defined in claim 1, further comprising disposing an image-on-web sensor upstream of the spreader in the process direction and sensing the marked pixel linewidth.

6. The method defined in claim 5, wherein the step of disposing an image-on-web sensor includes disposing a full width array in the cross process direction.

7. The method defined in claim 5, wherein the step of disposing an image-on-web sensor includes disposing a full width array.

8. The method defined in claim 1, wherein the step of disposing a spreader includes disposing a heater and a pressure controlled nip.

9. The method defined in claim 1, wherein the step of controlling the spreading includes disposing a controller and connecting the controller for receiving output signals from the showthru and linewidth sensor and connecting the controller for controlling the nip pressure and heater temperature.

10. The method defined in claim 9, wherein the step of disposing a controller includes disposing a proportional-integral-derivative (PID) controller.

11. The method defined in claim 9, wherein the step of disposing a controller includes disposing a controller having a look-up table of values of heater set point as a function of pixel linewidth and nip pressure as a function of pixel linewidth.

12. The method defined in claim 1, further comprising disposing a linewidth sensor and a showthru sensor.

13. A control system for controlling pixel linewidth for ink jet marking on continuous web print media comprising:
(a) a spreader disposed proximate the web downstream of the marking engine in the process direction for controlling dot spread of the marking;
(b) one of a showthru sensor and a linewidth sensor disposed proximate the web downstream of the spreader in the process direction and operative to provide an output signal; and,
(c) a controller disposed to receive the output signals from the showthru sensor and linewidth sensor and operatively connected for controlling the spreader.

14. The system defined in claim 13, wherein the spreader includes a pressure controllable nip and a controllable heater.

15. The system defined in claim 13, wherein the one of linewidth sensor and showthru sensor have a resolution of about 600 spots per inch and with signal processing provide a cross process resolution of about 3 micrometers (μm).

16. The system defined in claim 13, further comprising an image-on-web marking sensor disposed upstream of the spreader in the process direction.

17. The system defined in claim 16, wherein the image-on-web marking sensor has a resolution of about 600 spots per inch and with signal processing provides a cross process resolution of about 3 micrometers (μm).

18. The system defined in claim 13, wherein the controller includes a proportional-integral-derivative (PID) controller.

19. The system defined in claim 13, wherein the controller includes a look-up table of values of heater set temperature as a function of linewidth and values of nip pressure as a function of linewidth.

20. The system defined in claim 13 further comprising a showthru sensor and a linewidth sensor.
